(19) United States
(12) Patent Application Publication
(10) Pub. No.: US 2015/0065258 A1
(43) Pub. Date: Mar. 5, 2015

(54) MICROCHIPPED TOY FOR INTERACTIVE ENTERTAINMENT

(71) Applicant: Christopher John Meade, Charlotte, NC (US)

(72) Inventor: Christopher John Meade, Charlotte, NC (US)

(21) Appl. No.: 14/477,346

(22) Filed: Sep. 4, 2014

Related U.S. Application Data
(60) Provisional application No. 61/873,786, filed on Sep. 4, 2013.

(51) Int. Cl. A63F 13/235; A63F 13/98

(52) U.S. Cl. CPC A63F 13/235; A63F 13/98
USPC 463/43

(57) ABSTRACT

Systems and methods are provided for using one or more scannable microchips embedded in a toy to allow for an interactive play experience. Through the use of an interactive gameplay application associated with the toy, commands or other data associated with a scannable microchip can be used to alter the gameplay experience. In specific embodiments, data associated with a scannable microchip embedded in a toy is used to alter traits of a playable character associated with the gameplay application and provide an enhanced gameplay experience.

### CLAIM OF PRIORITY UNDER 35 U.S.C. §119

The present Application for Patent claim priority to Provisional Application No. 61/873,786 entitled “Microchipped Toy for Interactive Entertainment” filed Sep. 4, 2013, the entirety of which is hereby incorporated by reference.

### BACKGROUND

Toys are a part of every child's life and can be vital to a child's educational and social development. Enhancing a child's interaction with a toy is beneficial to the child's growth in these areas.

### BRIEF SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later. Methods, systems, and computer program products are defined for an interactive toy, embedded with or attached to a microchip tag, which allows users to achieve enhanced website and gameplay experiences. In some embodiments of the invention, a toy company may provide an interactive application to the user, the interactive application related to a toy belonging to the user, and the toy comprising a microchip tag for communicating information and commands to the toy company. The receipt of such commands prompts the toy company to provide an action to the user, the action enhancing the interactive experience of the user.

For example, a toy company provides a user with a toy, the toy embedded with or attached to a microchip tag. The toy company also provides the user with a gameplay application, accessible to computer systems connected to a network. While the user is interacting with the gameplay application on the user's tablet, the toy company prompts the user to scan the microchip tag with the tablet in order to receive a special gameplay power. The toy company then receives an indication that the microchip tag has been scanned, and the toy company receives a command from the tablet. The toy company then identifies the command as a prompt to increase a virtual gaming character's jumping ability. The toy company then determines an appropriate response to the command and provides the user with a virtual gaming character with increased jumping ability.

In some embodiments, a system is provided, the system comprising: a memory device having computer readable program code stored thereon; and a processing device operatively coupled to the memory device, wherein the processing device is configured to execute the computer readable program code to: receive an indication that a user has scanned a microchip tag with a computing device, the microchip tag being embedded within or attached to a toy; receive a command associated with the toy from the computing device; identify the command received from the computing device; determine an action in response to the command identified, wherein the action is associated with an enhancement of the interactive toy experience of the user; and provide the action to the user.

In some embodiments of the invention, a computer program product is provided, the computer program product comprising at least one non-transitory computer-readable medium having computer-readable program code portions embodied therein, the computer-readable program code portions comprising: an executable portion configured to receive an indication that a user has scanned the microchip tag with a computing device; an executable portion configured to receive a command from a computing device, wherein the command is associated with a toy; an executable portion configured to identify the command received from the computing device; an executable portion configured to determine an action in response to the command identified; and an executable portion configured to provide the action to the user.

In some embodiments of the invention, a method is provided, the method comprising: providing a toy with a scannable microchip tag to a user; receiving an indication that the user has scanned the microchip tag with a computing device; receiving, by a processing device, a command related to the toy from the computing device; identifying, by the processing device, the command received from the computing device; determining, by the processing device, an action in response to the command identified; and providing, by the processing device, the action to the user.

To the accomplishment of the foregoing and related ends, the one or more embodiments comprise the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, which are not necessarily drawn to scale, and wherein:

FIG. 1 illustrates a high level process flow of an interactive toy and entertainment process, in accordance with one embodiment of the invention;

FIG. 2 illustrates a block diagram of an interactive toy and entertainment system environment, in accordance with one embodiment of the invention;

FIG. 3 illustrates a process flow of an interactive toy and website process, in accordance with one embodiment of the invention;

FIG. 4 illustrates a process flow of an interactive toy and gaming application process, in accordance with one embodiment of the invention;

FIG. 5 illustrates a block diagram of an interactive toy system, in accordance with one embodiment of the invention;

FIG. 6 illustrates a block diagram of an interactive toy system, in accordance with one embodiment of the invention;

FIG. 7 depicts a screenshot of an interactive website, in accordance with one embodiment of the invention;

FIG. 8 depicts a screenshot of an interactive website, specifically a Profile page, in accordance with one embodiment of the invention;

FIG. 9 depicts a screenshot of an interactive website, specifically a Pictures page, in accordance with one embodiment of the invention;

FIG. 10 depicts a screenshot of an interactive website, specifically a Design page, in accordance with one embodiment of the invention; and

FIG. 11 depicts a screenshot of a gameplay application, in accordance with one embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. In the following description, for purposes of explanation, numerous specific details are set forth in order to provide a thorough understanding of one or more embodiments. It may be evident; however, that such embodiment(s) may be practiced without these specific details. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Like numbers refer to like elements throughout.

Various embodiments or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

The steps and/or actions of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. A storage medium may be coupled to the processor, such that the processor can read information from, and write information to, the storage medium. In the alternative, the storage medium may be integral to the processor. Further, in some embodiments, the processor and the storage medium may reside in an Application Specific Integrated Circuit (ASIC). In the alternative, the processor and the storage medium may reside as discrete components in a computing device. Additionally, in some embodiments, the events and/or actions of a method or algorithm may reside as one or any combination or set of codes and/or instructions on a machine-readable medium and/or computer-readable medium, which may be incorporated into a computer program product.

In one or more embodiments, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures, and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc”, as used herein, include compact disc (CD), laser disc, optical disc, digital versatile disc (DVD), floppy disk and Blu-Ray disc where disks usually reproduce data magnetically, while discs usually reproduce data optically with lasers. Combinations of the above should also be included within the scope of computer-readable media.

Thus methods, systems, computer program products, and the like are herein disclosed that provide for an interactive toy, embedded with or attached to a microchip, which allows users to achieve enhanced website and gameplay experiences. The microchipped toy may provide users with a means to communicate with a toy company such that the toy company may take an action in furtherance of the enhanced experience of the user. In some embodiments, the toy company may provide an interactive website to the user, the interactive website being associated with the toy. In other embodiments, the toy company may provide a gameplay application to the user, the gameplay application being associated with the toy. In these or other embodiments, the user may scan the microchip embedded within or attached to the toy to send a command to the toy company. In response to the command, the toy company may provide an action directed to the interactive website experience and the gameplay application experience, respectively.

In some embodiments, an interactive website may be an interactive web application. In some embodiments, a gameplay application may be a gameplay website.

As used herein, “toy company” means any person, entity, institution, or the like that is in the business of providing toys to consumers or providing an interactive entertainment or educational experience related to a toy. This could be a software company, a website or application hosting company, or another type of one or more companies that provides the toy, application, or invention described herein.

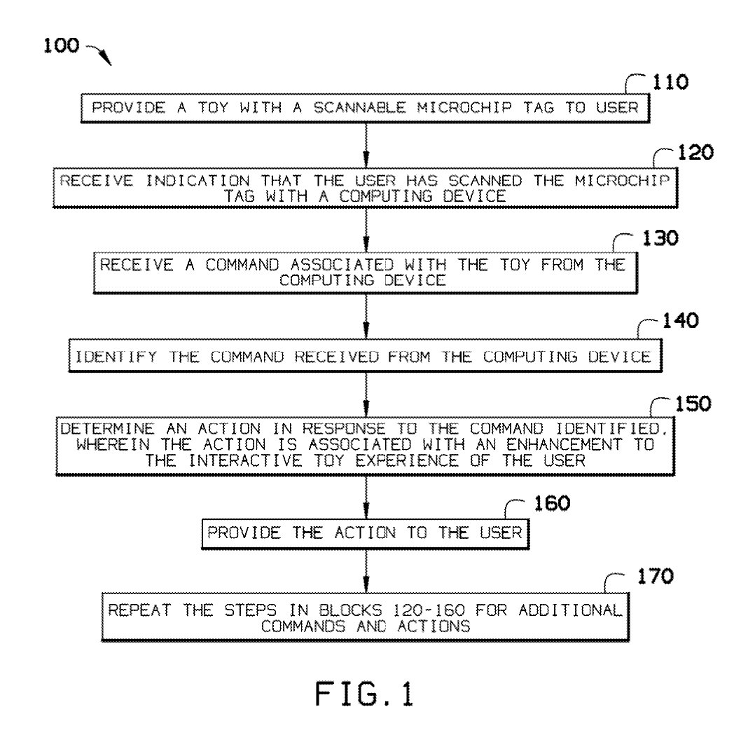

FIG. 1 illustrates a high level process flow for an interactive toy and entertainment process 100. As illustrated by block 110 in FIG. 1, the toy company provides a toy with a scannable microchip tag to a user. For example, the toy company may sell a plush toy animal with a microchip embedded within or attached to the front-left foot of the toy. The toy company may also make the user aware of the microchip tag and encourage or prompt the user to scan the microchip tag with a computer system, the computer system being a computing device.

Block 120 of FIG. 1 illustrates that an indication that the user has scanned the microchip tag with a computing device is received by the toy company. This indication is received by a communication device in the toy company system, the communication device configured to communicate with a network, of which the user's computer system has access.

FIG. 1 illustrates in block 130 that the toy company receives a command associated with the toy from the computing device. The command associated with the toy may be a prompt to the toy company to perform a specific or general action to the user, through an interactive website and/or a gameplay application.

As illustrated by block 140 in FIG. 1, the toy company identifies the command received from the computing device. For example, the toy company may identify the command received from the computing device as a prompt to direct the user to a profile page within the interactive website. In some embodiments, multiple commands will be received from the computing device at the same time. In such embodiments, the processing device of the toy company system may determine which application the user is interacting with and choose the command that best enhances the experience associated with that application. In some embodiments, the processing device of the toy company system may identify multiple commands as appropriate to enhance the interactive experience of the user.

Block 150 of FIG. 1 illustrates that the toy company determines an action in response to the command identified, wherein the action is associated with an enhancement of the interactive toy experience of the user. The processing device of the toy company system determines the appropriate method to execute the prompt of the command. For example, a toy company that receives the command “increase jumping power” may determine that the action “increase the jumping power of the virtual gaming character by 10 percent” is the appropriate response. The next time the toy company receives the “increase jumping power” command, the toy company may determine that the action “increase the jumping power of the virtual gaming character by 20 percent” is the appropriate response.

FIG. 1 illustrates in block 160 that the toy company provides the action to the user. For example, the toy company may increase the jumping power of the virtual gaming character by 10 percent. The toy company's act of providing an action, stemming from a scanned microchip, enhances the user's interactive experience with the toy and applications provided to the user by the toy company.

As illustrated by block 170 in FIG. 1, the toy company repeats the steps in blocks 120-160 for additional commands and actions, as needed. In some embodiments of the invention, the user may scan the same microchip tag multiple times. Each scan of the tag may be identified by the toy company, restarting the process at block 120. In other embodiments, the toy company has provided multiple microchips embedded within or attached to the toy. In such embodiments, the user may scan different microchip tags. Each scan of a microchip tag in this embodiment may be identified by the toy company system, thus restarting the process at block 120.

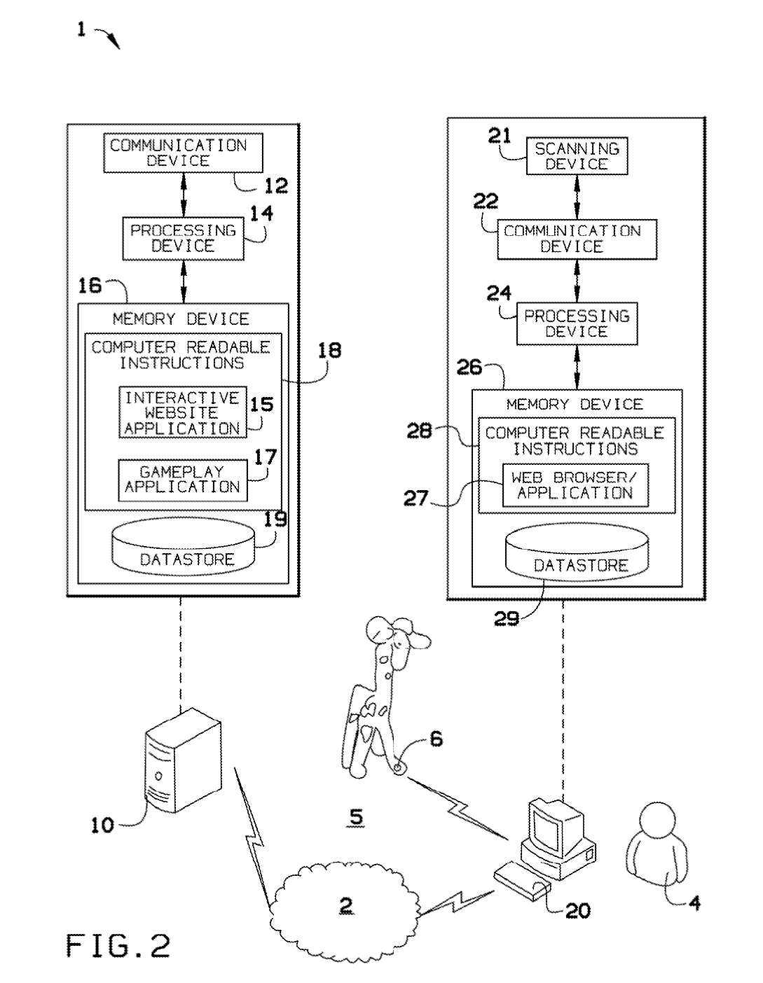

FIG. 2 illustrates a recurring payment system environment, in accordance with an embodiment of the present invention. As illustrated in FIG. 2, one or more user computer systems 20 are operatively coupled, via a network 2, to a toy company system 10. In this way one or more users 4 may utilize the user computer systems 20 to access an interactive website 15 or a gameplay application 17 for enhancing their interactive experience. In other embodiments, a portion, or all of, the interactive website 15 and the gameplay application 17 may be stored on the user computer systems 20. In other embodiments, as described later, a portion, or all of, the interactive website 15 or gameplay application 17 may be stored on the toy company systems 10. In still other embodiments of the invention a portion, or all of, the interactive website 15 and the gameplay application 17 (as well as other applications or information) may be stored on third-party systems (e.g., cloud computing, or other systems).

The network 2 may be a global area network (GAN), such as the Internet, a wide area network (WAN), a local area network (LAN), or any other type of network or combination of networks. The network 2 may provide for wireline, wireless, or a combination of wireline and wireless communication between devices on the network 2.

In some embodiments of the invention the one or more users 4 are the customers of the toy company, or an agent, guardian, or the like of a person or entity that is a customer of the toy company.

As illustrated in FIG. 2, the toy systems 5 generally comprise one or more microchip tags 6. As used herein, the term “microchip tag” generally includes apparatuses configured to communicate a signal to the scanning device 21 of the user computer systems 20. In some embodiments, the microchip tag 6 is powered by a battery and constantly emits a signal (e.g. a powered radio-frequency identification, or “RFID,” tag). In other embodiments, the microchip tag 6 is not powered and emits a signal when prompted by a scanning device through a change in the electro-magnetic field surrounding the microchip tag 6 (e.g. a near-field communication, or “NFC,” tag). In some embodiments, the microchip tag 6 is an image or coded symbol that may be digitally scanned by a scanning device (e.g. a bar code or a quick response, “QR,” code). In some embodiments, the microchip tag 6 is capable of being reconfigured and/or reprogrammed. In some such embodiments, one or more sets of data, commands, instructions and/or other information stored on the microchip tag 6 can be amended, replaced, and/or rewritten. For example, new and/or additional instructions associated with a new aspect of an interactive gameplay application or another aspect of that interactive gameplay application can be written to the microchip tag. In some such examples, the new and/or additional instructions are associated with one or more traits of a gameplay character. In some embodiments, microchip tag 6 can be reconfigured and/or reprogrammed by the user. For example, a scanning device may be used to convey data and/or other signals to reconfigure and reprogram the microchip tag. In some embodiments, the microchip tag 6 may be reconfigured and/or reprogrammed by the manufacturer or the vendor. For example, the user of the toy may be invited to attend an event or visit a location associated with the manufacturer or vendor to engage in reprogramming or reconfiguration of the microchip tag 6.

In some embodiments of the invention, the microchip tag 6 is embedded within the toy system 5. In other embodiments of the invention, the microchip tag 6 is attached to the exterior of the toy system 5 as a tag or label. In some embodiments of the invention, multiple microchip tags 6 are associated with the toy system 5 such that each microchip tag is distinct from the others and may emit unique signals.

The toy 5 may be any toy used by children or adults and may be any shape or size, so long as the toy 5 may be associated with a microchip tag 6. In one embodiment, the toy may be a plush toy sewn from a textile and stuffed with a soft material. In some embodiments of the invention, the toy 5 is provided to the user 4 by the toy company. In some embodiments of the invention, multiple versions of toys 5 may be available to users 4 such that the toys 5 have different characteristics and names. In one embodiment of the invention, the toy 5 may be a creature containing blends of the physical characteristics of multiple different animals. The animals may be real or imaginary, or a combination of partially real and partially imaginary.

As illustrated in FIG. 2, the user computer systems 20 generally comprise a scanning device 21, a communication device 22, a processing device 24, and a memory device 26. The processing device 24 is operatively coupled to the scanning device 21, the communication device 22, and the memory device 26. The user computer systems 20 may be a desktop, laptop, tablet, mobile device (e.g., smartphone device), or any other type of computer or computing device that generally comprises a scanning device 21 communication device 22, a processing device 24, and a memory device 26.

As used herein, the term “scanning device” generally includes circuitry used for detecting, triggering, and receiving signals sent from microchip tags. For example, a scanning device 21 may be an NFC reader, an RFID reader, a QR code reader, or the like. The scanning device 24 is configured to receive a signal from the microchip tags 6 and communicate the signal to the other components of the user computer systems 20, such as the processing device 24.

As used herein, the term “processing device” generally includes circuitry used for implementing the communication and/or logic functions of a particular system. For example, a processing device 24 may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 24 uses the communication device 22 to communicate with the network 2 and other devices on the network 2, such as, but not limited to, the toy company systems 10 or other systems. As such, the communication device 22 generally comprises a modem, server, or other device for communicating with other devices on the network 2 and/or a keypad, keyboard, touch-screen, touchpad, microphone, mouse, joystick, other pointer device, button, soft key, and/or other input device(s) for communicating with the user 4.

As further illustrated in FIG. 2, the user computer systems 20 comprise computer-readable instructions 28 stored in the memory device 26, which in one embodiment includes the computer-readable instructions 28 of a web browser or other application 27. In some embodiments, the memory device 26 includes a datastore 29 for storing data related to the user computer systems 20, including, but not limited to, data created and/or used by the web browser or other application 27. As illustrated in FIG. 2, a user 4 may access or receive information about the interactive website 15 and/or the gameplay application 17 through the web browser or other application 27.

As illustrated in FIG. 2, the toy company systems 10 generally comprise a communication device 12, a processing device 14, and a memory device 16. The processing device 14 is operatively coupled to the communication device 12 and the memory device 16. The processing device 14 uses the communication device 12 to communicate with the network 2 and other devices on the network 2, such as, but not limited to, the user computer systems 20 and/or other systems. As such, the communication device 12 generally comprises a modem, server, or other device for communicating with other devices on the network 2.

As illustrated in FIG. 2, the toy company systems 10 may have computer-readable instructions 18 stored in the memory device 16, which in one embodiment includes the computer-readable instructions 18 of an interactive website 15 and a gameplay application 17 that provides an interactive experience for the user 4. In some embodiments, the memory device 16 includes a datastore 19 for storing data related to the toy company systems 10, including but not limited to data created and/or used by the interactive website 15 and/or the gameplay application 17. The interactive website 15 may be utilized by the user 4 to view profile information associated with the toy 5, design new versions of a toy 5, communicate with others in a social network, and the like, as explained in further detail below.

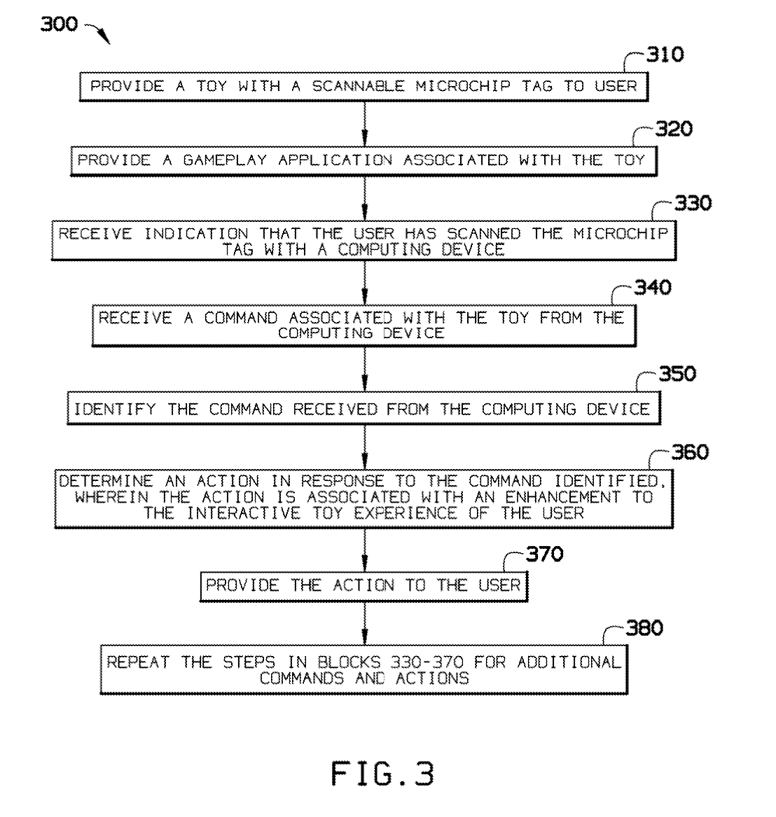

FIG. 3 illustrates a process flow for an interactive toy and website process 300. As illustrated by block 310 in FIG. 3, the toy company provides a toy with a scannable microchip tag to a user. For example, the toy company may sell a plush toy animal with a microchip embedded within or attached to the front-left foot of the toy. The toy company may also make the user aware of the microchip tag and encourage or prompt the user to scan the microchip tag with a computer system, the computer system being a computing device.

Block 320 of FIG. 3 illustrates that the toy company provides an interactive website associated with the toy. In some embodiments of the invention, the toy company provides the interactive website such that the user may access the interactive website freely, without interacting with the toy. In other embodiments, the user must scan the toy in order to be provided access to some or all of the features of the interactive website, as discussed below.

FIG. 3 illustrates in block 330 that the toy company receives an indication that the user has scanned the microchip tag with a computing device. This indication is received by a communication device in the toy company system, the communication device configured to communicate with a network, of which the user's computer system has access.

As illustrated by block 340 in FIG. 3, the toy company receives a command associated with the toy from the computing device. The command associated with the toy may be a prompt to the toy company to perform a specific or general action to the user, through the interactive website.

Block 350 of FIG. 3 illustrates that the toy company identifies the command received from the computing device. For example, the toy company may identify the command received from the computing device as a prompt to direct the user to a Profile page within the interactive website.

FIG. 3 illustrates in block 360 that the toy company determines an action in response to the command identified, wherein the action is associated with the interactive website. Continuing the example from the previous paragraph, the toy company system determines, through the processing device, that computer readable instructions should be provided to the interactive website such that the Profile page will be provided to the user.

As illustrated by block 370 of FIG. 3, the toy company then provides the action to the user. Continuing the example, the toy company system then actually provides the computer readable instructions and the interactive website therefore provides the user with the Profile page.

Block 380 of FIG. 3 illustrates that the toy company repeats the steps in blocks 330-370 for additional commands and actions, as needed. In some embodiments of the invention, the user may scan the same microchip tag multiple times. Each scan of the tag may be identified by the toy company, restarting the process at block 330. In other embodiments, the toy company has provided multiple microchips embedded within or attached to the toy. In such embodiments, the user may scan different microchip tags. Each scan of a microchip tag in this embodiment may be identified by the toy company system, thus restarting the process at block 330. In other embodiments of the invention one or more of the microchips may be scanned and the process may determine the commands and actions for multiple scans at the same time. In still other embodiments of the invention multiple microchips are scanned in secession or in a pattern in order to create a command and/or an associated action based on the secession or pattern in which the microchips were scanned.

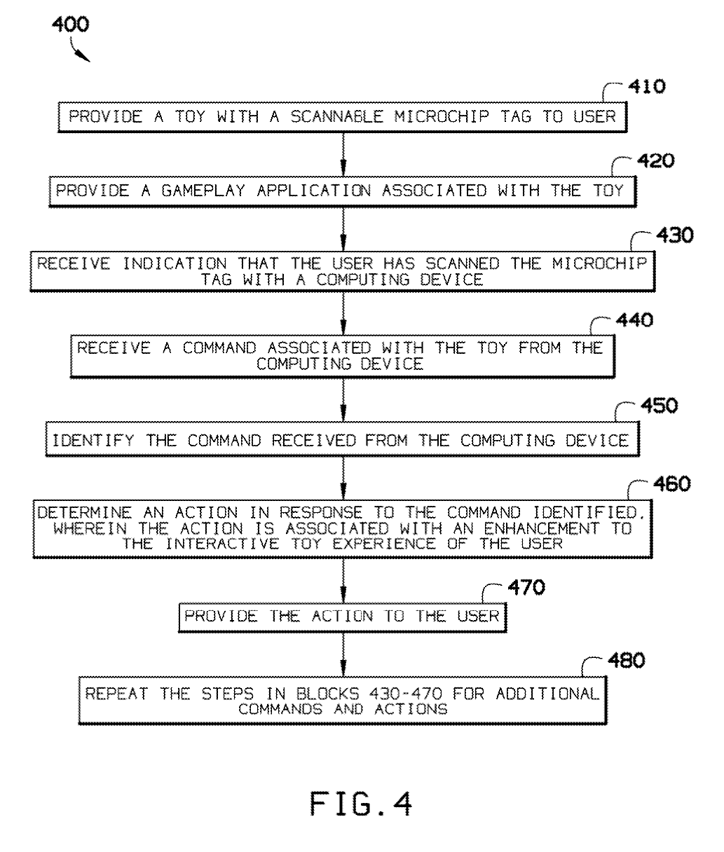

FIG. 4 illustrates a process flow for an interactive toy and gaming application process 400. As illustrated by block 410 in FIG. 4, the toy company provides a toy with a scannable microchip tag to a user. For example, the toy company may sell a plush toy animal with a microchip embedded within or attached to the front-left foot of the toy. The toy company may also make the user aware of the microchip tag and encourage or prompt the user to scan the microchip tag with a computer system, the computer system being a computing device.

Block 420 of FIG. 4 illustrates that the toy company provides a gaming application associated with the toy. In some embodiments of the invention, the toy company provides the gaming application such that the user may access the gaming application freely, without interacting with the toy. In other embodiments, the user must scan the toy in order to be provided access to some or all of the features of the gaming application.

FIG. 4 illustrates in block 430 that the toy company receives an indication that the user has scanned the microchip tag with a computing device. This indication is received by a communication device in the toy company system, the communication device configured to communicate with a network, of which the user's computer system has access.

As illustrated by block 440 in FIG. 4, the toy company receives a command associated with the toy from the computing device. The command associated with the toy may be a prompt to the toy company to perform a specific or general action to the user, through a gaming application.

Block 450 of FIG. 4 illustrates that the toy company identifies the command received from the computing device. For example, the toy company may identify the command to be a prompt to increase the jumping power of a virtual gaming character.

FIG. 4 illustrates in block 460 that the toy company determines an action in response to the command identified, wherein the action is associated with the gaming application. Continuing the example from the paragraph above, the toy company may determine that the appropriate response to a command of “increase jumping power” is an action to “increase the jumping power of the virtual gaming character by 10 percent.” In one embodiment, the next time the toy company receives the command of “increase jumping power,” the toy company may determine that the action “increase the jumping power to 20 percent” is appropriate.

As illustrated by block 470 of FIG. 4, the toy company then provides the action to the user. For example, the toy company may provide computer readable instructions to the gaming application to increase the jumping power of the virtual gaming character by 10 percent.

Block 480 of FIG. 4 illustrates that the toy company repeats the steps in blocks 430-470 for additional commands and actions, as needed. In some embodiments of the invention, the user may scan the same microchip tag multiple times. Each scan of the tag may be identified by the toy company, restarting the process at 430. In other embodiments, the toy company has provided multiple microchips embedded within or attached to the toy. In such embodiments, the user may scan different microchip tags. Each scan of a microchip tag in this embodiment may be identified by the toy company system, thus restarting the process at block 430. In other embodiments of the invention one or more of the microchips may be scanned and the process may determine the commands and actions for multiple scans at the same time. In still other embodiments of the invention, multiple microchip tags are scanned in secession or in a pattern in order to create a command and/or an associated action based on the secession or pattern in which the microchips were scanned. For example, the user 4 may have to scan microchip tags in both feet of the animal before the “jumping power” is increased.

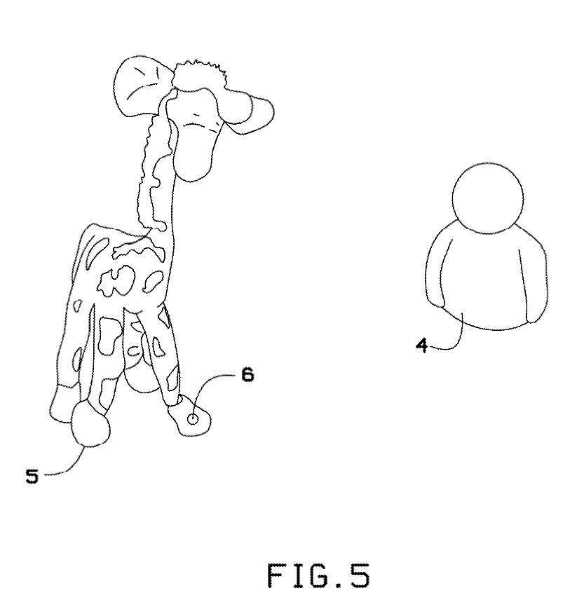

FIG. 5 illustrates one embodiment of a toy system 5 in an interactive toy and entertainment system, the toy system 5 comprising a single microchip tag 6 embedded within or attached to the front-left foot of the toy 5. The microchip tag 6 may be embedded within or attached to the toy 5 in any area, such as an arm, leg, wing, tail, or the like. The microchip tag 6 may be waterproof, allowing the user 4 to wash the toy 5. This washable nature is a benefit to users 4 desiring cleanliness, especially when the user is a child. The microchip tag 6 may be encased within any type of material that allows for the signal from the microchip tag 6 to be read by a scanning device 21. In some embodiments of the invention, the toy company 10 provides the user 4 with the toy system 5. In one embodiment of the invention the microchip tag 6 may provide multiple signals to the scanning device 21 such that the toy company 10 is directed to provide multiple actions to the user 4 from the single scan of the microchip tag 6.

In some embodiments of the invention, the toy company 10 provides a speech recognition and response system. In one embodiment of the speech recognition and response system, the user computer system 20 contains a microphone and a speaker operatively connected with the processing device. The computer system 20 is then able to respond to oral prompts with a pre-set audio reply. In another embodiment of the speech recognition and response system, the toy company 10 provides a toy 5 comprising a microphone, speaker, and processing device embedded within or attached to the toy 5, in addition to the microchip tag 6. In such an embodiment, the microphone detects oral prompts, the processing device analyzes the oral prompt, and transmits an audial response through the speaker. In one embodiment of the speech recognition and response system, provided by the toy company 10, multiple toys 5 may audibly communicate with each other through the same speech recognition and response system.

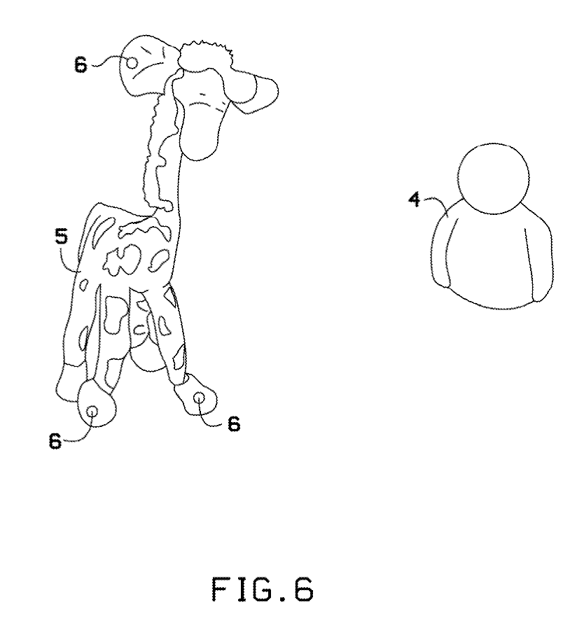

FIG. 6 illustrates one embodiment of a toy system 5 in an interactive toy and entertainment system, the toy system 5 comprising multiple microchip tags 6 embedded within or attached to separate regions of the toy 5. In one embodiment of the invention, each of the plurality of distinct microchip tags 6 may provide a distinct signal to the scanning device 21, and thus induce the toy company 10 to perform a plurality of distinct actions. Such an embodiment is beneficial to a user 4 because it allows for greater functionality in the interaction between the user 4, the toy 5, the interactive website 15, and the gameplay application 17. For example, when the user 4 is playing a game within the gameplay application 17, the toy company 10 may receive an indication that the user 4 has scanned a microchip tag 6 associated with the foot of the toy, and the toy company 10 may then provide an action to the user 4 of increasing the jumping power of the gameplay character. Subsequently, the toy company 10 may receive an indication that the user has scanned a microchip tag 6 associated with the head of the toy 5, and the toy company 10 may then provide an action to the user 4 of increasing the vision distance of the gameplay character.

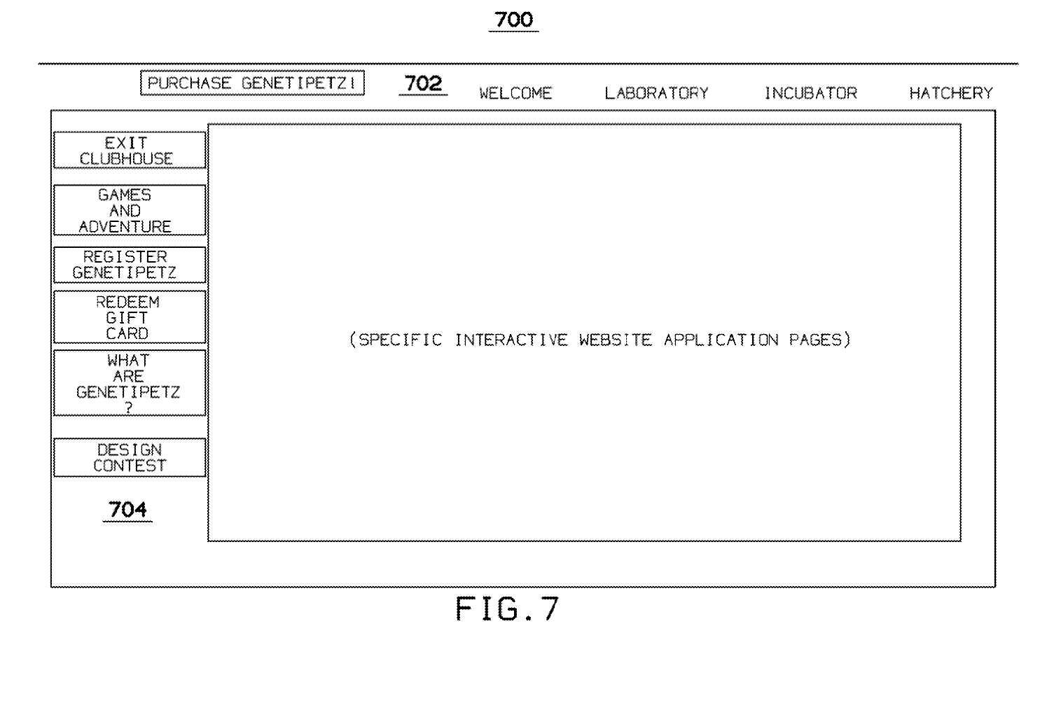

The interactive website 15 may be provided by the toy company 10 in several embodiments. As illustrated in FIG. 7, the user interface 700 of the interactive website 15 may have a stationary navigation bar 702, a tabbed menu 704, and a section for specific website material 706. In some embodiments of the invention, the navigation bar 702 of the interactive website 15 may provide links for a user 4 to navigate to a Profile page, a Purchase Toy page, a Welcome page, a Laboratory page, an Incubator page, a Hatchery page, a Voting page, or the like. This list is a non-exhaustive list intended only as an explanatory example. In some embodiments of the invention, the user interface 704 of the interactive website 15 may provide a tabbed menu 704 with links for a user 4 to navigate to a Profile page, a Registration page, a Gift Card page, an About page, a Design page, a Pictures page, or the like. Again, this list is non-exhaustive and included for example purposes only. The example links from the navigation bar 702 may be used on the tabbed menu 704 and vice-versa. Some links may be used on both the navigation bar 702 and the tabbed menu 704. In some embodiments of the invention, a link to the gaming application 17 may be included in the navigation bar 702 and/or the tabbed menu 704.

In one embodiment of the invention, a menu tab is provided by the toy company 10 to the user 4, the menu tab dedicated to listing the different toys 5 owned by the user 4. In another embodiment, the toy company 10 provides a menu tab to the user 4 that lists the friends of the user 4 and which toys 5 the friends of the user 4 own.

In some embodiments of the invention, parts of the interactive website 15 are not provided to the user 4 by the toy company 10 until the toy company 10 has received a specific command associated with an action to unlock interactive website 15 features from a user computer system 20. In some embodiments of the invention, the toy company 10 may prompt the user 4 to scan a microchip tag 4 such that the toy company 10 may provide additional features of the interactive website 15 to the user 4.

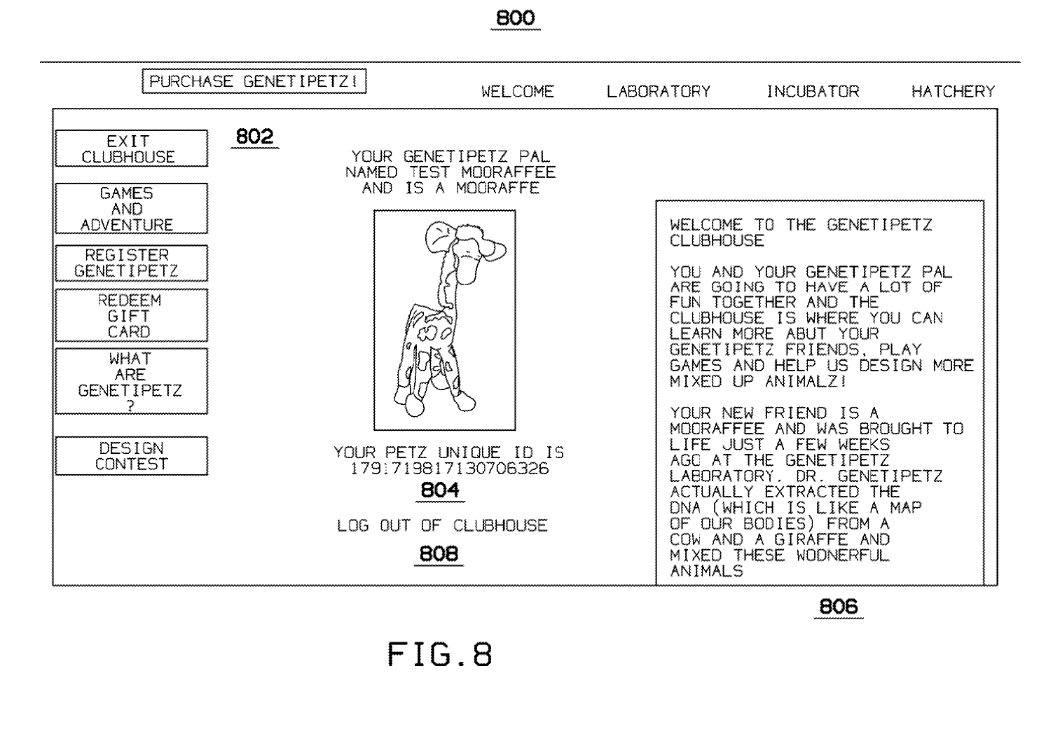

FIG. 8 depicts an embodiment of the interactive website 15, specifically a Profile page 800. In some embodiments of the invention, the name “Profile” is substituted for a similar term (e.g. “Clubhouse,” “Home,” “Base,” etc.). In some embodiments of the invention, the toy company 10 provides the Profile page 800 to the user 4 without the need for an interaction with the toy 5. In some embodiments, the action provided by the toy company 10 to the user 4 is to direct the user 4 to the Profile page 800 of the interactive website 15. In such an embodiment, the toy company 10 may always provide the action of directing the user to the Profile page 800 of the interactive website 15 when the user 4 is not interacting with either the interactive website 15 or the gameplay application 17 at that point in time.

The Profile page 800 may include any combination of a welcome message 802, a profile overview 804, an information section 806, a log-out link 808, or the like. In some embodiments, the welcome message 802 is a generic message. In other embodiments, the welcome message 802 is individualized by the toy company 10 to the user 4 or the toy 5. In some embodiments of the invention, the profile overview 804 includes a name for the toy 5, an image of the toy 5 (or a picture of the same type of toy), a unique identification code for the toy, gameplay achievement information associated with the user 4, and other general information related to the toy 5, the user 4, the interactive website 15, and the gameplay application 17. In some embodiments of the invention, the information section 806 includes a background history of the toy 5, specific traits of the toy 5 (both real and fictional), and other general information associated with the toy 5 and the Profile page 800. In some embodiments of the invention, the log-out link 808 allows a user to log out of the interactive website 15.

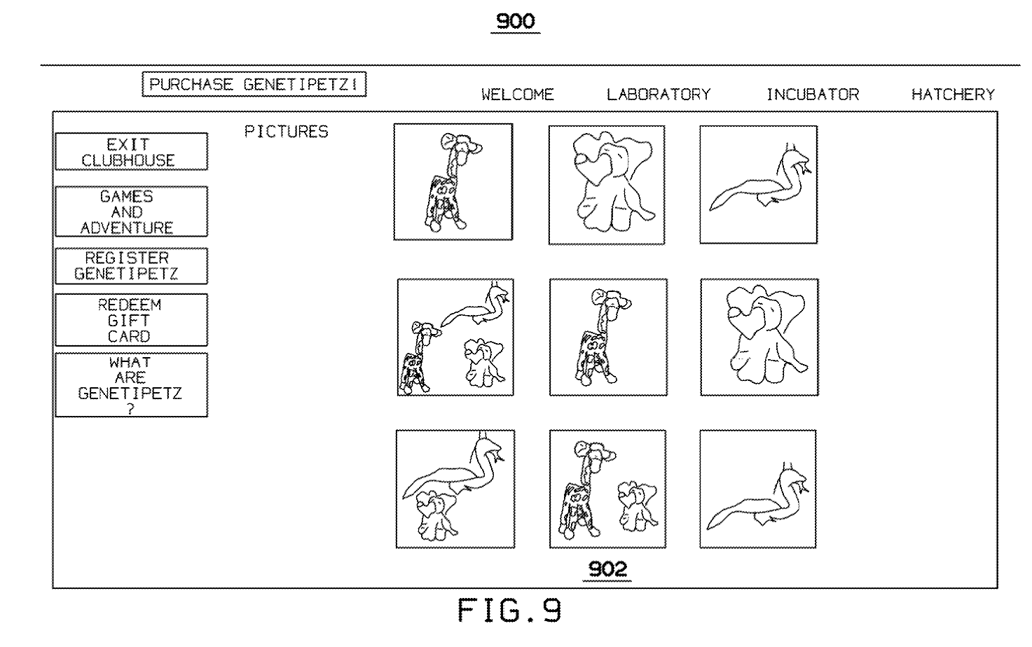

FIG. 9 depicts an embodiment of the interactive website, specifically a Picture page 900. In some embodiments of the invention, the toy company 10 provides an interface dedicated to displaying and organizing pictures 902 taken by the user 4. In such an embodiment, the toy company 10 may provide a system for allowing the user 4 to upload pictures to the interactive website interface 15. In other embodiments, the toy company 10 may provide a system for allowing the user 4 to take pictures with the user computer system 20, wherein the user computer system 20 comprises a camera device.

In some embodiments of the invention, the Picture page 900 provided by the toy company 10 may include a caption or story text box underneath the pictures. In such an embodiment, users 4 may write captions for the picture of the toy or tell stories about adventures with the toy.

In some embodiments of the invention, the toy company 10 may provide the Picture page 900 as a social network of multiple users 4 interacting with each other. In such an embodiment, a user's 4 picture of the toy may be viewed by other users. In some embodiments of the invention, users 4 may comment on the pictures of other users in the social media setting.

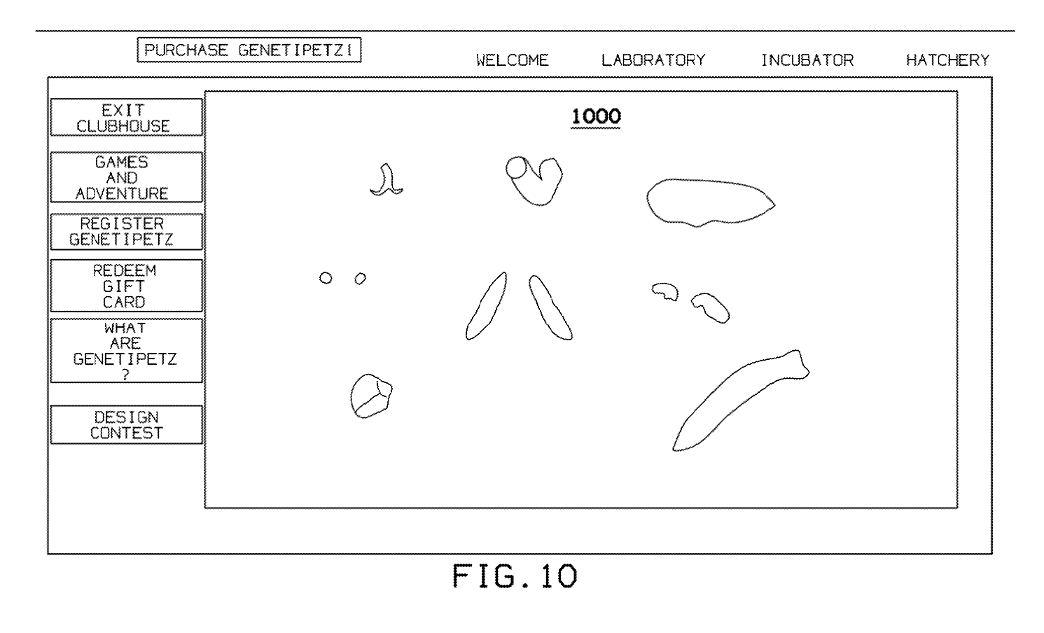

FIG. 10 illustrates an embodiment of the interactive website 15 provided by the toy company 10, specifically a Design page 1000. The Design page 1000 may be configured to allow users 4 to create their own animal creations, similar to the toy 5 of the user 4. In one embodiment of the invention, as shown in FIG. 10, the toy company 10 provides an interface to allow users 4 to piece together pre-created animal parts 1002 and piece them together to create unique creatures. In other embodiments, the toy company 10 provides an interface to the user 4 which allows the user 4 to draw new creatures using a virtual pen or paintbrush. In some embodiments of the invention, the toy company 10 may provide an election system wherein the user 4 may submit a new creature design and all users 4 vote on their favorite design, with the winning design being put to market by the toy company 10.

In some embodiments of the invention, the gameplay application 17 is a separate application from the interactive website 15. In other embodiments, the gameplay application 17 is a function of the interactive website 15. In some embodiments, the toy company 10 provides an action of directing the user 4 to the gameplay application 17 after the toy company 10 receives a command from the user computer system 20.

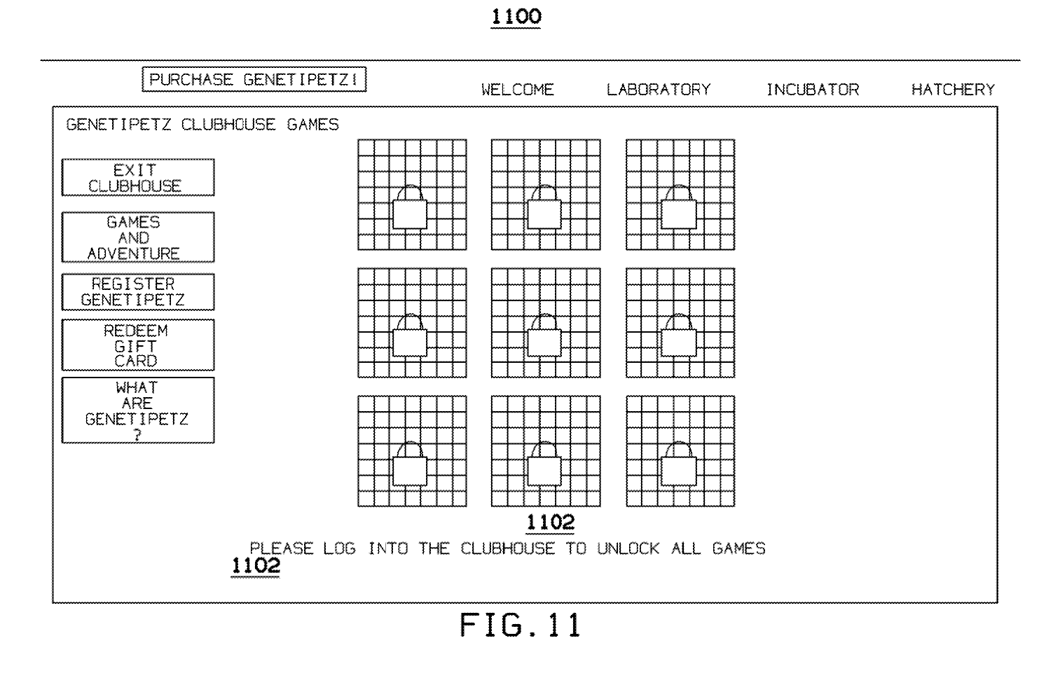

FIG. 11 illustrates one embodiment of a user interface 1100 of a gaming application 17. As illustrated in FIG. 11, the toy company 10 may provide a user interface to the user 4 configured to allow the user 4 to play one of a plurality of games 1102. In one embodiment of the invention, the toy company 10 provides no restrictions to the user 4 for which games 1102 may be accessed by the user 4. In another embodiment of the invention, the toy company 10 may prompt the user 4 to register the toy 5 of the user 4 before the user 4 may access a set of games. In such an embodiment, the toy company 10 may provide a link 1104 to the user 4 configured to allow the user 4 to login to the gaming application 17. In some embodiments, the toy company 10 may prompt the user 4 to scan a microchip tag 6 in order for the user 4 to access a set of games in the gaming application 17.

In another embodiment of the invention, the gaming application 17 may comprise a single virtual gaming world containing a single multiple game or multiple smaller games within the virtual gaming world. In one embodiment of the invention, the toy company 10 provides a digital currency to the user 4, the digital currency configured to be used by the user 4 to purchase power-ups, special features, and gameplay extras. The toy company 10 may provide digital currency to users 4 when the users 4 achieve certain levels within the gameplay. The toy company 10 may also provide a system which allows users 4 to purchase digital currency through an online store.

In one embodiment of the invention, the toy company 10 provides the virtual gaming world such that the user 4 is the sole player within the virtual gaming world. In another embodiment of the invention, the toy company 10 may provide a system for allowing multiple users 4 to participate in the virtual gaming world through the same gameplay application 17. An example of this is two friends playing a game on the same tablet. In another embodiment of the invention, the toy company 10 may provide a system for allowing multiple users 4 to participate in the virtual gaming world through separate gameplay applications 17. An example of this is two friends playing the same game, but each friend playing the game on a different tablet.

Within a virtual gaming world embodiment of the invention, the toy company 10 may provide a virtual representation of the toy 5 associated with the user 4, as well as interactive locations within the virtual world. Locations within the virtual gaming world may include a laboratory, a hatchery, a house for the virtual representation of the toy, a house for the virtual representation of a user's 4 friend's toy, gaming zones, educational zones, reading zones, and the like.

In some embodiments of the invention, the toy company 10 provides a system configured to allow the user 4 to control the virtual gaming character with a mouse, keyboard, joystick, electronic controller, or the like. In other embodiments of the invention, the toy company 10 provides a system configured to allow the user 4 to control the virtual gaming character with the toy 5 of the user 4.

In one embodiment of invention with the toy 5 of the user 4 utilized as a controller, the toy company 10 provides a camera system wherein the camera tracks the motion of the toy 5 and a processor within the user computer system 20 determines movement information from the tracked information and provides directional responses for the virtual gaming character. For example, the virtual gaming character may jump in the virtual gaming world as a reaction to an upward movement of the toy 5, as viewed by the camera.

In another embodiment of the invention, the toy company 10 provides a toy 5 comprising a gyroscope and accelerometer configured to transmit movement information to the user computer system 20. The processing device 24 then determines directional responses for the virtual gaming character in the gameplay application 17.

While the foregoing disclosure discusses illustrative embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any embodiment may be utilized with all or a portion of any other embodiment, unless stated otherwise.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

As will be appreciated by one of skill in the art in view of this disclosure, the present invention may be embodied as an apparatus (e.g., a system, computer program product, and/or other device), a method, or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product comprising a computer-usable storage medium having computer-usable program code/computer-readable instructions embodied in the medium.

Any suitable computer-usable or computer-readable medium may be utilized. The computer usable or computer readable medium may be, for example but not limited to, an electronic, magnetic, optical, electromagnetic, infrared, or semiconductor system, apparatus, or device. More specific examples (a non-exhaustive list) of the computer-readable medium would include the following: an electrical connection having one or more wires; a tangible medium such as a portable computer diskette, a hard disk, a random access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the present invention may be written in an object oriented, scripted or unscripted programming language such as Java, Pearl, Smalltalk, C++ or the like. However, the computer program code/computer-readable instructions for carrying out operations of the invention may also be written in conventional procedural programming languages, such as the “C” programming language or similar programming languages.

Embodiments of the present invention described above, with reference to flowchart illustrations and/or block diagrams of methods or apparatuses (the term “apparatus” including systems and computer program products), will be understood to include that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

Specific embodiments of the invention are described herein. Many modifications and other embodiments of the invention set forth herein will come to mind to one skilled in the art to which the invention pertains, having the benefit of the teachings presented in the foregoing descriptions and the associated drawings. Therefore, it is to be understood that the invention is not to be limited to the specific embodiments disclosed and that modifications and other embodiments and combinations of embodiments are intended to be included within the scope of the appended claims. Although specific terms are employed herein, they are used in a generic and descriptive sense only and not for purposes of limitation.

1. A system for an interactive toy experience comprising:
a toy;
a first scannable microchip tag embedded in the toy;
an interactive gameplay application associated with the toy; and
a first set of data stored on the first scannable microchip tag, wherein the first set of data is associated with a first command capable of being received by the interactive gameplay application, and wherein the interactive gameplay application is configured to alter a first attribute of a virtual gaming character associated with the interactive gameplay application in response to receiving the first command.

2. The system of claim 1, wherein the toy comprises a representation of a physical characteristic of a first creature and a representation of a physical characteristic of a second creature.

3. The system of claim 2, further comprising a second scannable microchip tag embedded in the toy and a second set of data stored on the second scannable microchip tag, wherein the second set of data is associated with a second command capable of being received by the interactive gameplay application, and wherein the interactive gameplay application is configured to alter a second attribute of the virtual gaming character associated with the interactive gameplay application in response to receiving the second command.

4. The system of claim 3 wherein the first scannable microchip tag is embedded in a first portion of the toy and wherein the second scannable microchip tag is embedded in a second portion of the toy.

5. The system of claim 4, wherein the virtual gaming character comprises a representation of the toy.

6. The system of claim 5, wherein the first attribute of the virtual gaming character is associated with an attribute of the first portion of the toy, and wherein the second attribute of the virtual gaming character is associated with an attribute of the second portion of the toy.

7. The system of claim 1 further comprising a scanning device configured to detect the first data set and transmit the first data set to a processing device associated with the interactive gameplay application.

8. A system for an interactive to experience comprising:
a toy comprising a first portion and a second portion, wherein the first portion comprises a representation of a first creature and wherein the second portion comprises a representation of a second creature;
a first scannable microchip tag, wherein the first scannable microchip tag is affixed to the first portion of the toy;
a gameplay application associated with the toy, wherein the gameplay application is configured to:
receive an indication that a user has scanned the first scannable microchip tag with a computing device;
receive a first command associated with the toy from the computing device;
identify the first command received from the computing device; and
enhance, in response to identifying the first command received from the computing device, a first aspect of a gameplay character associated with the gameplay application.

9. The system of claim 8 wherein the first creature is different from the second creature.

10. The system of claim 8 further comprising a second scannable microchip tag, wherein the second scannable microchip tag is affixed to the second portion of the toy.

11. The system of claim 10, wherein a set of data associated with the first command associated with the toy is stored on the first scannable microchip tag and wherein a set of data associated with a second command associated with the toy is stored on the second scannable microchip tag; and
wherein the first scannable microchip tag is reprogrammable and wherein the second microchip tag is reprogrammable.

12. The system of claim 11, wherein the gameplay application is further configured to:
receive an indication that a user has scanned the second scannable microchip tag with a computing device;
receive the second command associated with the toy from the computing device;
identify the second command received from the computing device; and
enhance, in response to identifying the second command received from the computing device, a second aspect of the gameplay character associated with the gameplay application.

13. The system of claim 12 wherein the first aspect of the gameplay character is different from the second aspect of the gameplay character.

14. The system of claim 13, further comprising displaying the first aspect of the gameplay character and the second aspect of the gameplay character to the user.

15. A method of gameplay comprising:
providing a toy with a scannable microchip tag to a user;
receiving an indication that the user has scanned the microchip tag with a computing device;
receiving, by a processing device, a command related to the toy from the computing device;
identifying, by the processing device, the command received from the computing device;
determining, by the processing device, an action in response to the command identified; and
providing, by the processing device, the action to the user.

16. The method of claim 15, wherein the action is associated with an interactive gameplay application.

17. The method of claim 16, wherein the action comprises an enhancement to an aspect of a gameplay character associated with the interactive gameplay application.

18. The method of claim 17, wherein the toy comprises a first portion and a second portion, wherein the first portion comprises a representation of a first creature and wherein the second portion comprises a representation of a second creature.

19. The method of claim 18, wherein the toy comprises a plurality of scannable microchip tags, wherein each scannable microchip tag within the plurality of scannable microchip tags is affixed to the toy.

20. The method of claim 19, wherein each scannable microchip tag within the plurality of scannable microchip tags is associated with a set of commands related to the toy.
